(19) United States
(12) Patent Application Publication
(10) Pub. No.: US 2014/0171176 A1
(43) Pub. Date: Jun. 19, 2014

(54) SYSTEM AND METHOD FOR OPTIMIZING A WINNINGS VALUE OF A GAMING DEVICE

(71) Applicant: Net Entertainment NE AB, Stockholm (SE)

(72) Inventors: Jonas Strandman, Stockholm (SE); Tibor Maksai, Kista (SE)

(73) Assignee: Net Entertainment NE AB, Stockholm (SE)

(21) Appl. No.: 14/013,102

(22) Filed: Aug. 29, 2013

Related U.S. Application Data
(60) Provisional application No. 61/732,999, filed on Dec. 4, 2012.

(51) Int. Cl. G07F 17/34

(52) U.S. Cl. CPC G07F 17/34
USPC 463/20

(57) ABSTRACT

A system and method for optimizing the final winnings value of a slot machine or other gaming device, comprising: obtaining a slot machine result, wherein the result comprises result values arranged in an N rows by M columns matrix of cells and an identified position within said matrix; determining an original winnings value; determining a subset of adjacent matrix cells as being adjacent to said identified position; determining all possible cell pairs within said determined subset; for each of said possible cell pairs: determine a modified matrix based on the result; determine a winnings value for said cell pair; comparing all determined winnings values, wherein all determined winnings values include the original winnings value and the winnings values determined for each modified matrix; determining a maximum winnings value from said comparison of all winnings values; and if the maximum winnings value is greater than zero, set the final winnings value of the slot machine result to the maximum winnings value; if the maximum winnings value is not greater than zero, repeat the previous method steps.

### TECHNICAL FIELD

Generally, embodiments of the invention relate to the technical field of casino games.

More specifically, different embodiments of the application relate to optimizing the winnings value of a casino game, such as a slot machine or video slot.

### BACKGROUND

In general casino gaming relate to operating a casino device where an input is made, a result is generated and a winnings value is determined based on the generated result.

Such games are sometimes referred to as slot machine, fruit machine, the slots, poker machine, slot or one-armed bandits

In prior art solutions the winnings value is determined immediately after the result is generated resulting in a static game user experience and a non-optimal combination of the gaming result.

Therefore the inventor has identified a need for an enhanced game user experience and an improved gaming result.

These and other considerations have been addressed by the current invention which is described more fully below in the description. Additional benefits and advantages of the current invention will be given below or will be apparent from the nature of the invention.

### RELATED ART

An example of related art is found in the following document:

US20070010417 A1

However, the related art does not disclose the solutions of the present invention.

### SUMMARY

In prior art solution the winnings value is determined immediately after the result is generated resulting in a static game user experience and a non-optimal combination of the gaming result.

Therefore the inventor has identified a need for an enhanced game user experience and an improved gaming result.

In accordance with embodiments described herein, the identified needs are met by providing an enhanced gaming experience to a game user, or player, and/or to provide an improved gaming result or optimized winnings value.

In accordance with embodiments, the winnings value is optimized by adapting the generated result based on predefined conditions, functions, logic or rules.

In an embodiment, there is provided a method for optimizing the final winnings value of an enhanced slot machine, comprising:
obtaining a slot machine result, wherein the result comprises result values 310 arranged in an N rows 320 by M columns 330 two-dimensional matrix 300 of cells and an identified position 340 within said matrix;
determining an original winnings value as a function of said result values in said matrix;
determining a subset of adjacent matrix cells 410 as being adjacent to said identified position;
determining all possible cell pairs within said determined subset;
for each of said possible cell pairs:
   determine a modified matrix based on the result, wherein the position of the values of the two cells comprised in the cell pair is swapped compared to their positions in original the matrix;
   determine a winnings value for said cell pair as a function of the result values of said modified matrix;
comparing all determined winnings values, wherein all determined winnings values include the original winnings value and the winnings values determined for each modified matrix;
determining a maximum winnings value corresponding to the highest winnings value from said comparison of all winnings values;
determining whether the maximum winnings value is greater than zero; and
if the maximum winnings value is greater than zero, set the final winnings value of the slot machine result to the maximum winnings value;
   if the maximum winnings value is not greater than zero, repeat the previous method steps.

In accordance with embodiments described herein, a method for optimizing the final winnings value of a computing device, comprising:
obtaining a slot machine result, wherein the result comprises result values 310 arranged in an N rows 320 by M columns 330 original matrix 300 of cells and an identified position 340 corresponding to a cell within said matrix;
determining an original winnings value as a function of the result values in said original matrix;
determining a subset of adjacent matrix cells 410 as being adjacent to said identified position;
determining all possible cell pairs within said determined subset;
for each of said possible cell pairs:
determine a modified matrix, wherein the position of the values of the two cells comprised in the cell pair is swapped compared to their positions in the original matrix;
   determining a winnings value for said cell pair as a function of the result values of said modified matrix;
comparing all determined winnings values, wherein all determined winnings values include the original winnings value and the winnings values determined for each modified matrix;
determining a maximum winnings value corresponding to the highest winnings value from said comparison of all winnings values;
determining whether the maximum winnings value is greater than zero; and
if the maximum winnings value is greater than zero, set the final winnings value of the slot machine result to the maximum winnings value;if the maximum winnings value is not greater than zero, repeat the previous method steps
A method for optimizing the final winnings value of a computing device, comprising:
   obtaining a slot machine result, wherein the result comprises result values 310 arranged in an N rows 320 by M columns 330 original matrix 300 of cells and an identified position 340 corresponding to a cell within said matrix;
   determining an original winnings value as a function of the result values in said original matrix;
   determining a subset of adjacent matrix cells 410 as being adjacent to said identified position;
   determining all possible cell pairs within said determined subset;
   for each of said possible cell pairs:
      determine a modified matrix, wherein the position of the values of the two cells comprised in the cell pair is swapped compared to their positions in the original matrix;
      determining a winnings value for said cell pair as a function of the result values of said modified matrix;
comparing all determined winnings values, wherein all determined winnings values include the original winnings value and the winnings values determined for each modified matrix;
determining a winnings value corresponding by selecting a winnings value from said comparison of all winnings values;

In one embodiment, a method for optimizing the final winnings value of a computing device, comprising:
obtaining a slot machine result, wherein the result comprises result values 310 arranged in an N rows 320 by M columns 330 original matrix 300 of cells and an identified position 340 corresponding to a cell within said matrix;
   determining an original winnings value as a function of the result values in said original matrix;
determining a subset of adjacent matrix cells 410 as being adjacent to said identified position;
determining all possible permutations of result values within said determined subset;
for each of said possible permutations:
   determine a modified matrix for said permutation, wherein the position of the values are changed compared to their positions in the original matrix;
   determining a winnings value for said permutation as a function of the result values of said modified matrix;
comparing all determined winnings values, wherein all determined winnings values include the original winnings value and the winnings values determined for each modified matrix;
determining a winnings value corresponding by selecting a winnings value from said comparison of all winnings values;

In accordance with an embodiment, there is provided a system for optimizing the final winnings value of an enhanced slot machine, comprising: a result generator 30 and a game controller 20; wherein:
the result generator 30 is configured to generate a slot machine result, wherein the result comprises result values 310 arranged in an N rows 320 by M columns 330 original matrix 300 of cells and an identified position 340 corresponding to a cell within said matrix;
the game controller 20 is configured to obtain the slot machine result from the result generator 30, and determine an original winnings value based on the values of said original matrix; the game controller 20 further being configured to determine a subset of adjacent cells 410 as being adjacent to said identified position in the result and to determine all possible cell pairs within said subset; and for each of said possible cell pairs:
   determine a modified matrix, wherein the position of the values of the two cells comprised in the cell pair is swapped compared to their positions in the original matrix;
   determine a winnings value for said cell pair as a function of the values of said modified matrix;
the game controller 20 further being configured to comparing all determined winnings values, wherein all determined winnings values include the original winnings value and the winnings values determined for each modified matrix; determining a maximum winnings value corresponding to the highest winnings value from said comparison of all winnings values; determining whether the maximum winnings value is greater than zero; and
   if the maximum winnings value is greater than zero, set the final winnings value of the slot machine result to the maximum winnings value;
if the maximum winnings value is not greater than zero, repeat the previous method steps.

### BRIEF DESCRIPTION OF DRAWINGS

Embodiments of the invention will now be described in more detail with reference to the appended drawings, wherein:

FIG. 1 shows a flow diagram of method embodiments wherein an optimized winnings value is generated.

FIG. 2 shows a schematic view of a system embodiment.

FIG. 3 shows an embodiment of a result matrix.

FIG. 4 shows examples of identified adjacent cells.

### DETAILED DESCRIPTION

A general embodiment of a system and method for determining a winnings value according to the inventive concept is realized as a system and method for enabling an enhanced, or optimized, game result.

Background on Slot Machine Type Games

As mentioned previously general casino games and casino gaming relate to operating a casino device where a bet is placed, a user input is made, a result is generated and a winnings value is determined based on the generated result. In particular, the invention relates to games that are sometimes referred to as slot machine, fruit machine, the slots, poker machine, slot or one-armed bandits.

Casino games might be performed on any computing device performing functions as an enhanced slot machine and comprising a game controller, such as a processor in a smartphone, personal digital assistant (PDA), tablet personal computer, pocket personal computer, notebook computer, desktop computer, server computer, and the like.

Conventionally when playing a slot machine type game a user first selects a betting or coin value, activates the game, e.g. spin the reels of a slot machine, and is presented with a first result and a winnings value based on said first result, typically by evaluation of the result along one or a plurality predefined lines linking the values of the result or the presented symbols, also referred to as paylines, as would be understood by a person skilled in the art. The result might be generated by a first result generator which is in turn may be evaluated by a winnings value generator and presented to the game user via a user input/output device 215.

Determining a winnings value solely based on said pre-determined combination of said first result values might lead to a static game experience.

To further enhance the game experience a bonus game might be triggered when certain first result values are obtained. Thereby the bonus game is activated and a secondary evaluation of the winnings value by a winnings value generator is performed.

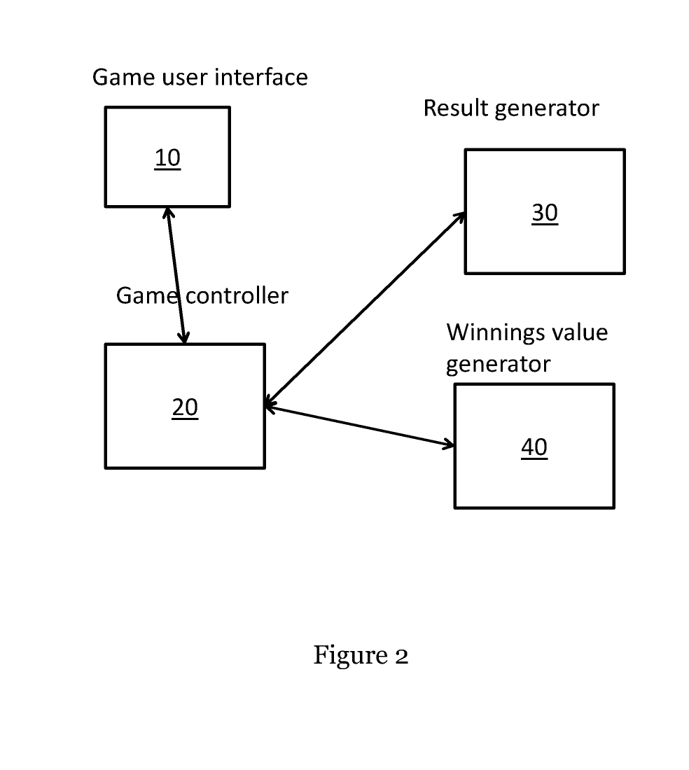

The inventor has realized that the gaming experience can be further improved by providing an enhanced gaming experience to a game user, or player, and/or to provide an improved gaming result or optimized winnings value, wherein the static game experience is improved by a secondary evaluation of the winnings value by a winnings value generator, thereby triggering a bonus type game. In FIG. 2, a schematic view of a system for optimizing the final winnings value of an enhanced slot machine embodiment is shown. The system comprises, in accordance with different embodiments presented herein, a game controller 30, a result generator 20 and optionally also a game user interface 10 and/or a winnings value generator 40. System embodiments and the function of the system units are further described in the section system architecture.

In one or more embodiments, the system for optimizing the final winnings value of an enhanced slot machine comprises, in accordance with different embodiments presented herein a game controller 30, e.g. a processor or processing unit provided with specifically designed programming or program code portions adapted to control the processing unit to perform one or more embodiments of the inventive method described herein. The system further comprises a result generator 20 adapted to generate a multidimensional value (M columns and N rows) slot machine result The system further comprises a memory 50 (Not shown in the figure) adapted to store and retrieve program code portions, parameters and historical or previous results of the second result generator. Said program code portions may be adapted to control the processing unit to perform various embodiments of the methods described further herein. Said parameters may be adapted to store values that are to be used as input for various tasks, such as determining a winnings value or any other operation that may utilize parameters, such as setting or retrieving betting or coin value. The system further comprises a communications interface 60 (not shown in the figure) configured to send or receive data values or parameters to/from a game controller 30 to/from external units via the communications interface 60. The system further comprises a winnings value generator 40 adapted to determine a winnings value based on the result of the result generator. In an alternative embodiment said winnings value generator 40 is adapted to determine a winnings value based on a parameter describing a betting value or coin value and the result of the result generator. Said winnings value generator 40 may be an integral part of the game controller 30, external to the game controller inside the system or external to the system and communicating via an external communications interface with the game controller 30. The system further comprises a user input/output device 10 adapted to receive data as a signal from the game controller 30 and display a representation of said data. Said user input/output device 10 is further adapted to receive user indications as data and send said indications as a signal to the game controller 30. Said user input/output device 10 may be a graphical user interface with touch functionality. The game controller 30 is communicatively coupled to said user input/output device 10, said memory 216, communications interface 60, said first result generator 219 and said second result generator 220. In one or more embodiments said game controller 30 is further communicatively coupled to said winnings value generator 221.

In one or more embodiments, said system is a video slot system.

According to one or more embodiments, a non-transitory computer-readable medium may be provided, wherein the computer-readable medium on which is stored instructions which, when executed by a processor/processing unit, non-transitory information adapted to controls the processor/processing unit to perform any of the methods for optimizing the final winnings value of an enhanced slot machine described herein.

In one or more embodiments, a computer program product may be provided that comprising code portions adapted to control a processor to perform any of the methods for optimizing the final winnings value of an enhanced slot machine described herein.

Game Overview

When a player clicks the play button or other inputter connected to a graphical user interface wherein the game is graphically presented to the user, a matrix with values is generated. A graphical representation of the matrix and symbols representing the matrix values are generated and presented in the user interface. When all values are in place, any winning bet lines are highlighted or indicated, and possibly also the winnings value, so that it is clear to the user what the outcome of the game round is.

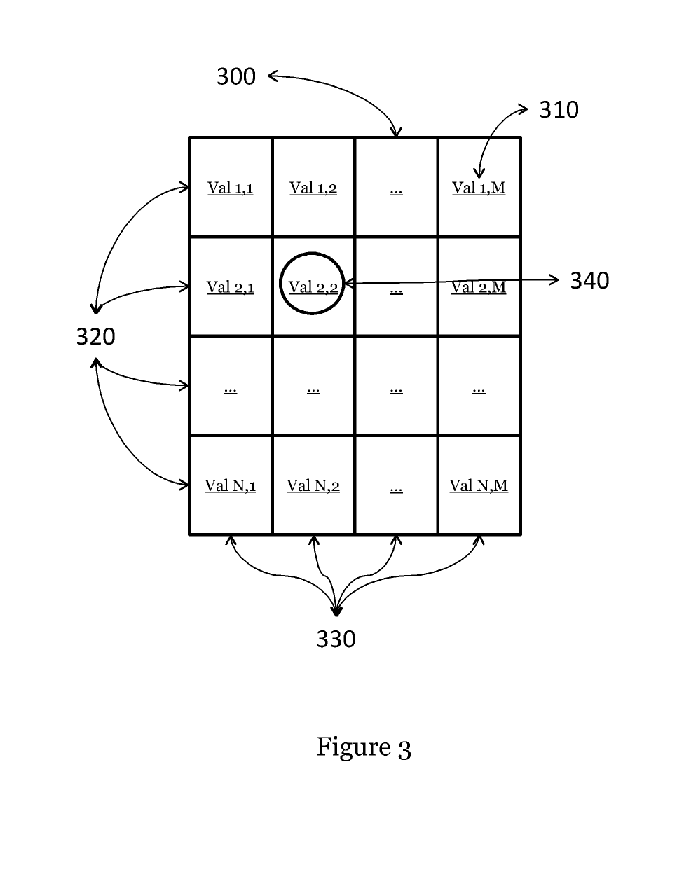

In accordance with an embodiment, when a spin, or game round, is initiated, for example by a user using an inputter connected to or communicatively coupled to the system, the result generator 30 is configured to generate a slot machine result. As illustrated in FIG. 3, the result comprises result values 310 arranged in an N rows 320 by M columns 330 original matrix 300 of cells and an identified position 340 corresponding to a cell within said original matrix.

System Architecture

In accordance with an embodiment, there is provided a system for optimizing the final winnings value of an enhanced gaming device, e.g. a slot machine, comprising: a result generator 30 and a game controller 20;

wherein:
the result generator 30 is configured to generate a slot machine result, wherein the result comprises result values 310 arranged in an N rows 320 by M columns 330 original matrix 300 of cells and an identified position 340 corresponding to a cell within said matrix;
the game controller 20 is configured to obtain the slot machine result from the result generator 30, and determine an original winnings value based on the values of said original matrix; the game controller 20 further being configured to determine a subset of adjacent cells 410 as being adjacent to said identified position in the result and to determine all possible cell pairs within said subset; and for each of said possible cell pairs:
   determine a modified matrix, wherein the position of the values of the two cells comprised in the cell pair is swapped compared to their positions in the original matrix;
   determine a winnings value for said cell pair as a function of the values of said modified matrix;
the game controller 20 further being configured to comparing all determined winnings values, wherein all determined winnings values include the original winnings value and the winnings values determined for each modified matrix; determining a maximum winnings value corresponding to the highest winnings value from said comparison of all winnings values; determining whether the maximum winnings value is greater than zero; and
   if the maximum winnings value is greater than zero, set the final winnings value of the slot machine result to the maximum winnings value;
   if the maximum winnings value is not greater than zero, repeat the previous method steps.

In accordance with an embodiment, the system further comprises a winnings value generator 40, wherein the game controller 20 is configured to obtain said slot machine result from the result generator 30, and to send the obtained result to the winnings value generator 40; and wherein the winnings value generator 40 is configured to determine the original winnings value, based on said received result, and to return a representation of said original winnings value to the game controller 20. In other words, determination or calculation of the original winnings value may be performed by logic comprised in the game controller, or in a specific winnings value generator 40. Such a winnings value generator may be integrated in, connected to or communicatively coupled to the game controller 30.

The system may further, in an embodiment, comprise a game user interface 10, wherein the game controller is further configured to, if the final winnings value corresponds to a winnings value determined from a modified matrix obtained by swapping the values of two cells in a specified cell pair in the original matrix: generate a graphical representation of the swapping of the two cells of the specified cell pair in the original matrix; and present the generated graphical representation in the game user interface 10.

In accordance with an embodiment, there is provided a system for optimizing the winnings value of an enhanced slot machine comprising:
a game user interface 10;
a game controller 20;
a result generator 30; and
a winnings value generator 40;
wherein the game controller is configured to obtaining a slot machine result,
wherein the result comprises result values 310 arranged in a N rows 320 by M columns 330 cells dimensional matrix 310 and a position 340 within said matrix, from the result generator 30;
wherein the game controller 20 is further configured to send the obtained result to the winnings value generator 40 and receive in response an original winnings value;
wherein the game controller 20 is further configured to determining a subset of adjacent cells 410 as being adjacent to said position in the result and to determine all possible combinations of pairs within said subset;
wherein the game controller is further configured to repeatedly for all of said possible pairs:
   determine a modified matrix based on the result, wherein the values of a possible pair is swapped in the matrix,
   determining a swapped winnings value based on said modified matrix by sending the modified matrix to the winnings value generator and receiving the swapped winnings value in response, and
   determine if the swapped winnings value is greater than the original winnings value and if so replace the result with the modified matrix and determine a maximum swapped winnings value as the swapped winnings value;
   wherein the game controller 20 is further configured to determine if the maximum swapped winnings value and the original winnings value is greater than zero and if not then repeat the previous steps;
   wherein the game controller 20 is further configured to determine an enhanced winnings value as the greater of the original winnings value and the maximum swapped winnings value.

Optimization of Winnings Values and the “Octopus”Feature

In accordance with an embodiment, the game graphics comprises a number of symbols, of which one is referred to as an “octopus wild” symbol. In accordance with embodiments, the identified position 340 corresponds to the position of an “octopus wild” value or symbol. in an embodiment, the main feature of the game is the octopus wild feature. Each time a user requests a spin, or in other words plays the game, either a normal spin or an octopus spin is generated. In an embodiment, a spin results in a graphical representation of the generated result matrix, obtained from the result generator 30. The graphical representation comprises game symbols placed on the different positions of the matrix. Octopus spins use a different reel set and the octopus wild is an overlay on a random position on the middle reel. In other words, after an octopus spin, a graphical of the octopus symbol is placed on one of the positions of the graphical representation of the matrix.

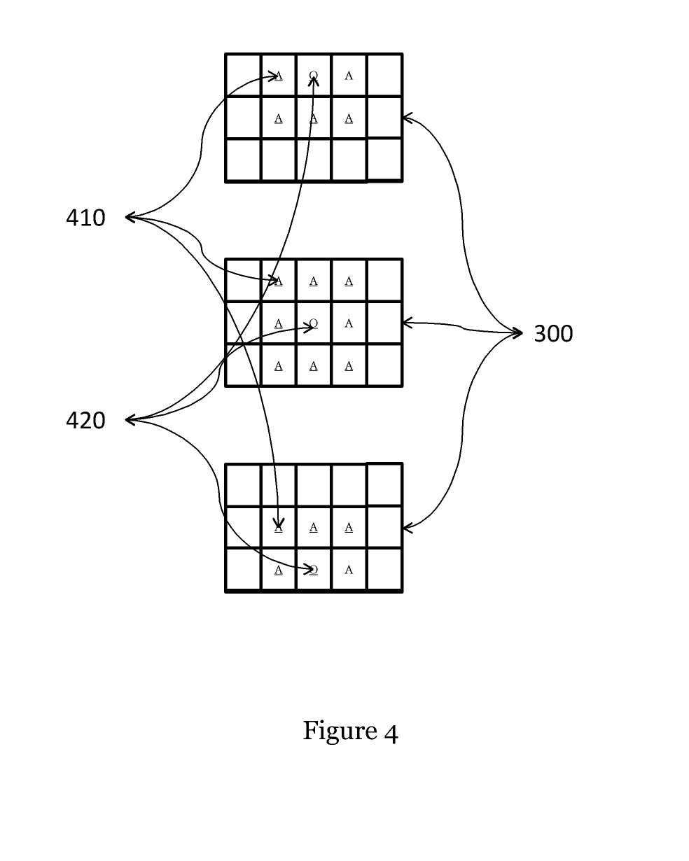

The position of the octopus is the basis for providing the ability to swap positions of other symbols in the matrix, according to method embodiments presented herein. A swap may be performed as long as the symbols are located on matrix cells adjacent to the cell on which the octopus symbol is located, as described further in connection with FIG. 4. Such a swap is performed in order to optimize the winnings result of the game, in accordance with the method embodiments presented herein.

Each base spin has a certain chance of being an octopus spin. Octopus spins use a different reel set and the octopus wild is an overlay at a random position on the middle reel. In embodiments, each position has an equal probability.

When the reels have stopped, and the position if the octopus is determined, the octopus will try to swap the position of two symbols, according to embodiments presented herein.

In one embodiment the matrix is graphically represented as e.g. a video slot with a number of bet lines (fixed), featuring a base game and a free-spin mode.

The octopus can reach all adjacent positions (not counting its own position). This is illustrated in the matrices 300 of FIG. 4, wherein the cell comprising an octopus symbol is labeled 420 and marked with an “o” and cells adjacent to a cell 420 are labeled 410 and marked with an “a”. In the example embodiments of FIG. 4, the matrices are 5×3 matrices. However, as is understood by someone skilled in the art, methods described herein may be adapted to fit a matrix having any suitable number of rows and columns, without going beyond the scope of the inventive concept.

In the first matrix shown in FIG. 4, there are 28 possible swaps. In the second and third matrices, there are 10 possible swaps.

In one example the game controller 20 creates the highest possible win for the player by swapping the positions of two symbols adjacent to the determined position 340.

In accordance with embodiments, if a swap is identified that enhances the winning value, the swap is performed and an enhanced final winning value is used. If the winnings value enhancing module does not find a suitable swap it remains active until a new result has been obtained. New results are generated until a swap opportunity occurs.

A swap is carried out as follow:
1. Calculate the original win for the spin.
2. Calculate what the win would be for all possible swaps of two symbols adjacent to the octopus.
3. If the win for the best possible swap is higher than the original win, the best swap is carried out and the win is awarded.
4. If the win for the best possible swap is the same as the original win, the win is awarded and all reels will re-spin with the octopus as sticky (using the same reels). The process is then repeated from step 1 until a swap is carried out.

Example Game Round

1. Octopus reels are used.

2. Reel outcome is generated

3. The octopus is randomized to the bottom position.

4. The game shows:
4 4 S 6 Q
6 J Q J T
3 K O 7 7

5. Current win is o and all swaps yield a win of o as well. Perform re-spin.

6. Reel outcome is (23, 45, 15, 59, 125).

7. The game shows:
6 Q T 6 J
3 7Q J T
J T O 7 A

8. Current win is o. The swap, marked with underlined symbols, yields a win of 12. The swap is performed and the win is awarded.

### Method Embodiments

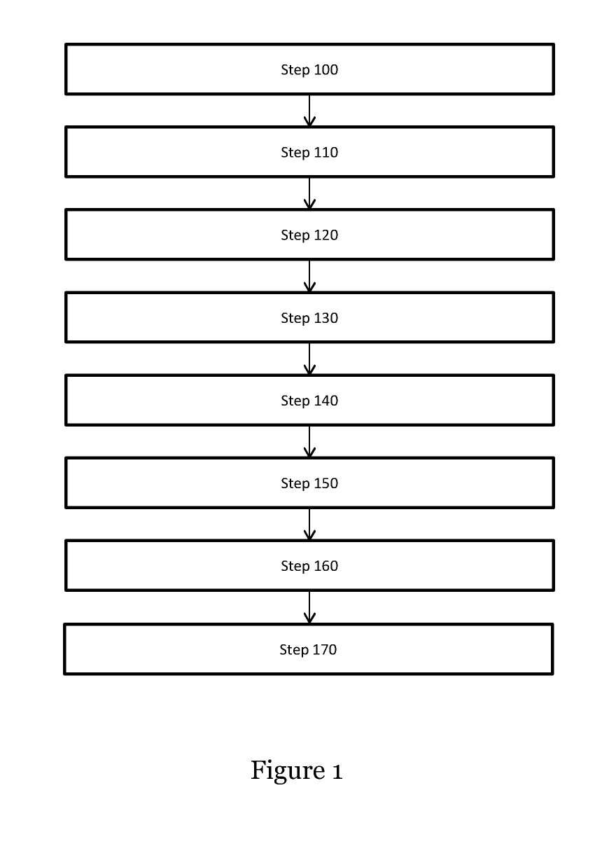

FIG. 1 shows a flow diagram of method embodiments wherein an optimized final winnings value is generated.

In accordance with an embodiment, there is provided a method for optimizing the final winnings value of an enhanced slot machine, comprising:

In step 100: Obtaining a game device or slot machine result.

According to embodiments, the result comprises result values 310 arranged in an N rows 320 by M columns 330 original matrix 300 of cells and an identified position 340 corresponding to a cell within said matrix.

In step 110: Determining an original winnings value.

In embodiments, the original winnings value is determined as a function of the result values in said original matrix obtained in step 100.

In step 120: Determining a subset of adjacent cells 410.

The subset of adjacent cells may be determined as being adjacent to the identified position.

In step 130: Determining all possible cell pairs within the determined subset.

In step 140: For each of said possible cell pairs:
determine a modified matrix, wherein the position of the values of the two cells comprised in the cell pair is swapped compared to their positions in the original matrix; and
determining a winnings value for said cell pair as a function of the result values of said modified matrix.

In other words, Step 140 comprises iteratively modifying the original matrix by swapping the values of all possible cell pairs of cells adjacent to the identified position and calculating the winnings value of the obtained modified matrices based on the values and positions of values of the modified matrices.

When all possible cell pairs have been processed in step 140, the method proceeds in step 150.

In step 150: Comparing all determined winnings values.

In accordance with embodiments, all determined winnings values include the original winnings value and the winnings values determined for each modified matrix in step 140.

In step 160: Determining a maximum winnings value.

In embodiments, the maximum winnings value corresponds to the highest winnings value, obtained from the comparison of all winnings values in step 150.

In step 170: Determining whether the maximum winnings value is greater than zero.

If the maximum winnings value is greater than zero step 170 comprises setting the final winnings value of the slot machine result to the maximum winnings value.

In an embodiment, the final winnings value corresponds to a winnings value determined from a modified matrix, obtained by swapping the values of two cells in a specified cell pair in the original matrix. According to this embodiment, the method further comprises: generating a graphical representation of the swapping of the two cells of the specified cell pair in the original matrix; and presenting the graphical representation of the swap to a user, using a graphical user interface.

If the maximum winnings value is not greater than zero, the previous method steps are repeated from step 100.

In accordance with an embodiment, there is provided a method for optimizing the winnings value of a an enhanced slot machine comprising: obtaining a slot machine result, wherein the result comprises result values 310 arranged in a N rows 320 by M columns 330 cells two-dimensional matrix 310 and a position 340 within said matrix; determining an original winnings value as a function of said matrix and said result values in said matrix; determining a subset of adjacent cells 410 as being adjacent to said position determining all possible combinations or pairs of cells within said subset; iteratively for all of said possible pairs:
determine a modified matrix based on the result, wherein the values of a possible pair is swapped in the matrix;
determining a swapped winnings value based on said modified matrix; and determine if the swapped winnings value is greater than the original winnings value and if so replace the result with the modified matrix and determine a maximum swapped winnings value as the swapped winnings value;
determine if the maximum swapped winnings value and the original winnings value is greater than zero and if not then repeat the previous steps; and
determine an enhanced winnings value as the greater of the original winnings value and the maximum swapped winnings value.

A general embodiment of a system for determining a winnings value according to the inventive concept is realized as a system for enabling an enhanced gambling result.

1. A method for optimizing the final winnings value of an enhanced slot machine, comprising:
obtaining a slot machine result, wherein the result comprises result values 310 arranged in an N rows 320 by M columns 330 original matrix 300 of cells and an identified position 340 corresponding to a cell within said matrix;
determining an original winnings value as a function of the result values in said original matrix;
determining a subset of adjacent matrix cells 410 as being adjacent to said identified position;
determining all possible cell pairs within said determined subset;
for each of said possible cell pairs:
i. determine a modified matrix, wherein the position of the values of the two cells comprised in the cell pair is swapped compared to their positions in the original matrix;
ii. determining a winnings value for said cell pair as a function of the result values of said modified matrix;
comparing all determined winnings values, wherein all determined winnings values include the original winnings value and the winnings values determined for each modified matrix;
determining a maximum winnings value corresponding to the highest winnings value from said comparison of all winnings values;
determining whether the maximum winnings value is greater than zero; and
i. if the maximum winnings value is greater than zero, set the final winnings value of the slot machine result to the maximum winnings value;
ii. if the maximum winnings value is not greater than zero, repeat the previous method steps.

2. The method of claim 1, wherein the final winnings value corresponds to a winnings value determined from a modified matrix, obtained by swapping the values of two cells in a specified cell pair in the original matrix, and wherein the method further comprises:
generating a graphical representation of the swapping of the two cells of the specified cell pair in the original matrix; and
presenting the graphical representation of the swap to a user, in a graphical user interface.

3. A system for optimizing the final winnings value of a an enhanced slot machine, comprising:
a result generator 30; and
a game controller 20;
wherein:
the result generator 30 is configured to generate a slot machine result, wherein the result comprises result values 310 arranged in an N rows 320 by M columns 330 original matrix 300 of cells and an identified position 340 corresponding to a cell within said matrix;
the game controller 20 is configured to obtain the slot machine result from the result generator 30, and determine an original winnings value based on the values of said original matrix;
the game controller 20 further being configured to:
determine a subset of adjacent cells 410 as being adjacent to said identified position in the result and to determine all possible cell pairs within said subset;
for each of said possible cell pairs:
i. determine a modified matrix, wherein the position of the values of the two cells comprised in the cell pair is swapped compared to their positions in the original matrix;
ii. determine a winnings value for said cell pair as a function of the values of said modified matrix;
comparing all determined winnings values, wherein all determined winnings values include the original winnings value and the winnings values determined for each modified matrix;
determining a maximum winnings value corresponding to the highest winnings value from said comparison of all winnings values;
determining whether the maximum winnings value is greater than zero; and
i. if the maximum winnings value is greater than zero, set the final winnings value of the slot machine result to the maximum winnings value;
ii. if the maximum winnings value is not greater than zero, repeat the previous method steps.

4. The system of claim 3, further comprising a winnings value generator 40, wherein
the game controller 20 is configured to obtain said slot machine result from the result generator 30, and to send the obtained result to the winnings value generator 40; and wherein
the winnings value generator 40 is configured to determine the original winnings value, based on said received result, and to return a representation of said original winnings value to the game controller 20.

5. The system of claim 3, further comprising a game user interface 10, wherein the game controller is further configured to, if the final winnings value corresponds to a winnings value determined from a modified matrix obtained by swapping the values of two cells in a specified cell pair in the original matrix:
generating a graphical representation of the swapping of the two cells of the specified cell pair in the original matrix; and present the generated graphical representation in the game user interface 10.

6. A method for optimizing the final winnings value of a computing device, comprising:
obtaining a slot machine result, wherein the result comprises result values 310 arranged in an N rows 320 by M columns 330 original matrix 300 of cells and an identified position 340 corresponding to a cell within said matrix;
determining an original winnings value as a function of the result values in said original matrix;
determining a subset of adjacent matrix cells 410 as being adjacent to said identified position;
determining all possible cell pairs within said determined subset;
for each of said possible cell pairs:
i. determine a modified matrix, wherein the position of the values of the two cells comprised in the cell pair is swapped compared to their positions in the original matrix;
ii. determining a winnings value for said cell pair as a function of the result values of said modified matrix;
comparing all determined winnings values, wherein all determined winnings values include the original winnings value and the winnings values determined for each modified matrix;
determining a maximum winnings value corresponding to the highest winnings value from said comparison of all winnings values;
determining whether the maximum winnings value is greater than zero; and
if the maximum winnings value is greater than zero, set the final winnings value of the slot machine result to the maximum winnings value; if the maximum winnings value is not greater than zero, repeat the previous method steps

7. A method for optimizing the final winnings value of a computing device, comprising:
obtaining a slot machine result, wherein the result comprises result values 310 arranged in an N rows 320 by M columns 330 original matrix 300 of cells and an identified position 340 corresponding to a cell within said matrix;
determining an original winnings value as a function of the result values in said original matrix;
determining a subset of adjacent matrix cells 410 as being adjacent to said identified position;
determining all possible cell pairs within said determined subset;
for each of said possible cell pairs:
i. determine a modified matrix, wherein the position of the values of the two cells comprised in the cell pair is swapped compared to their positions in the original matrix;
ii. determining a winnings value for said cell pair as a function of the result values of said modified matrix;
comparing all determined winnings values, wherein all determined winnings values include the original winnings value and the winnings values determined for each modified matrix;
determining a winnings value corresponding by selecting a winnings value from said comparison of all winnings values;

8. A method for optimizing the final winnings value of a computing device, comprising:
obtaining a slot machine result, wherein the result comprises result values 310 arranged in an N rows 320 by M columns 330 original matrix 300 of cells and an identified position 340 corresponding to a cell within said matrix;
determining an original winnings value as a function of the result values in said original matrix;
determining a subset of adjacent matrix cells 410 as being adjacent to said identified position;
determining all possible permutations of result values within said determined subset;
for each of said possible permutations:
i. determine a modified matrix for said permutation, wherein the position of the values are changed compared to their positions in the original matrix;
ii. determining a winnings value for said permutation as a function of the result values of said modified matrix;
comparing all determined winnings values, wherein all determined winnings values include the original winnings value and the winnings values determined for each modified matrix;
determining a winnings value corresponding by selecting a winnings value from said comparison of all winnings values;
